(19) United States
(12) Patent Application Publication
(10) Pub. No.: US 2021/0270050 A1
(43) Pub. Date: Sep. 2, 2021

(54) System to prevent injury from stair fall

(71) Applicant: Mirza Faizan, (US)

(72) Inventors: Mirza Faizan, Irving, TX (US); Bilal Syed Ali Shah, Murphy, TX (US); Yumna Syeda Ali Shah, Murphy, TX (US); Nimra Syeda Ali Shah, Murphy, TX (US); Mustafa Khaja Syed, Murphy, TX (US); Yaseen Khaja Syed, Murphy, TX (US)

(21) Appl. No.: 17/184,975

(22) Filed: Feb. 25, 2021

Related U.S. Application Data
(60) Provisional application No. 62/982,203, filed on Feb. 27, 2020.

(51) Int. Cl. E04G 21/32

(52) U.S. Cl. CPC E04G 21/3266; E04G 21/3204

(57) ABSTRACT

A fall protection system from stairs, that will allow children, elderly, disabled people to use the stairs safely by deploying as an instant safety net to stopping a child or an elderly or frail person from falling from the stairs.

### TECHNICAL FIELD

The present invention relates generally to protecting humans from injury and death due to falls, and in particular, relates to devices or methods to detect a fall and deploy a net in response thereto.

### BACKGROUND OF THE INVENTION

The elderly or children require assistance in walking up and down stairways and need a system to prevent accidental falls from the stairs. Often the side banister is insufficient to support or guide such persons. Further, when the person loses his or her grip on the banister, the person may fall down the stairs, possibly causing severe injury or death and among the children, elderly or disabled people.

Conventionally, several passive fall prevention devices such as stair fences and rail guides have been known, wherein U.S. Pat. No. 1,785,487, granted Dec. 16, 1980, to McAvoy, there is disclosed a stairway guard or gate which slides down and up a stairway.

Another U.S. Pat. No. 4,253,287, granted Mar. 3, 1981, to Overmoe, discloses walking bars that slide in guide slots, whereby the user can support his weight on the bar while moving up and down from one step to another.

| Patent Number | Issue Date | Patentee |
|---|---|---|
| US20090158666A1 | 2007-05-10 | Stephen Alexis AtkinsonSteven |
| | | Catterall |
| US5899298A | 1997-03-19 | Benjamin F. Crouse, Jr. |
| US5022197A | 1989-12-26 | Joel Aragona |
| US4899989A | 1988-11-21 | Michael J. KitsonDavid Williams |
| US5439342A | 1994-02-18 | John C. HallLee B. Petersen, Jr. |
| CN103711267A | | 2012-10-08 |
| CN204804366U | | 2015-02-13 |

All of these conventional methods/systems and some other methods/systems presently known in the art have had some flaws in design or mechanism and lacks precision. Most of the existing devices are too expensive and time consuming to be practical for most users. Some shortfalls of the existing method/system or a computer program product include manual interference. In light of this, there is a need for a method/system or a computer program product that overcomes these constraints.

In light of these facts, it is of great advantage to the safety of the human and its occupants that there is a system to accurately detect and prevent the human to fall from the stairs. There is a need for a system that is designed to detect and protect humans from injury and death due to falls, wherein the system detects a fall and deploys a net in response thereto to prevent injury due to falls.

None of the above inventions and patents, taken either singly or in combination, is seen to describe the present invention as claimed. Thus, a fall protection System for stairs to protect humans to fall from the stairs and solve the aforementioned problems is desired.

Features and advantages of the invention will be set forth in the description that follows, and in part will be apparent from the description, or may be learned by practice of the invention. The advantages of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

The present invention addresses the issues discussed above.

### SUMMARY OF THE INVENTION

The object of the present invention is to overcome the disadvantages of the prior arts and provide fall protection systems and methods for stairs while avoiding potential injury, wherein the system includes a sensor system operatively coupled with stairs and uses to detect a presence of the human on the stairs. Further, the sensor system may include one or more sensors suitable for detecting that the person is about to fall from stairs, wherein the detection is based on the sudden drop of the weight of the human detected by the weight sensor installed on each of the stairs and re-sense of the human user on the stairs and for detecting contact between the user and the stairs.

Further, the sensor sends the signal to a controller, wherein the controller controls a triggering mechanism to eject Expendable Retractable Rod to come-out of the openable-slot, wherein a safety net (14) is attached with the Expendable Retractable Rod that spreads covering the full width of the stair-stepin a case when the triggering mechanism receives the signals from the controller to eject the rod.

It is another object of the present invention, the fall protection systems for stairs include a pair of Expandable Retractable Rod, wherein the rods are mounted on a track disposed of adjacent to and in a plane parallel to the plane of a stair step. Further, a safety net is attached between the Expandable Retractable Rods, Furthermore, the safety net is used to hold the human in case the controller receives the signals from the sensor to start the trigger mechanism to eject Expendable Retractable Rod and come-out from an openable-slot, and simultaneously the safety net spreads covering the full width of the stair-step to stop the falling person right in the place. Additionally, the safety net is provided with a plastic strip curtain or net to further prevent the user from falling beneath the safety net and the stairs.

It is another object of the present invention, to provide a new and active fall protection system that will allow children, disabled or elderly people to use the stairs and prevent them from injury even after they have fallen from the stairs.

It is another object of the present invention, the present invention disclosed herein is a fall protection system and related method comprising a sensor; a controller to receive detections from the sensor, wherein the detections indicating that the person is about to fall; and at least one safety net, for deployment at at-least one location, in response to detecting fall conditions signal received from the controller.

Other objects, advantages, and features of this invention will become more apparent from the following description.

The details of one or more implementations are set forth in the accompanying description below. Other aspects, features, and advantages of the subject matter disclosed herein will be apparent from the description and the claims.

### BRIEF DESCRIPTION OF THE DRAWINGS

The accompanying drawings illustrate various embodiments of systems, methodₛ, and other aspects of the disclosure. Any person having ordinary skill in the art will appreciate that the illustrated element boundaries (e.g., boxes, groups of boxes, or other shapes) in the figures represent one example of the boundaries. It may be that in some examples, one element may be designed as multiple elements or that multiple elements may be designed as one element. In some examples, an element shown as an internal component of one element may be implemented as an external component in another and vice versa. Furthermore, elements may not be drawn to scale.

Features, elements, and aspects of the invention that are referenced by the same numerals in different figures represent the same, equivalent, or similar features, elements, or aspects in accordance with one or more embodiments.

The following figure depicts a certain illustrative embodiment of the invention. This depicted embodiment is to be understood as illustrative of the invention and not as limiting in any way.

Referring particularly to the drawing for illustration only and not limitation, there is illustrated:

FIG. 1 is a perspective schematic view illustrating a fall protection system for stairs;

FIG. 2 shows another perspective schematic views a fall protection system for stairs;

FIG. 3 shows another perspective schematic view illustrating a fall protection system for stairs; and

FIG. 4 shows a flow diagram according to the present invention.

### DETAILED DESCRIPTION OF DRAWINGS

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternate and suitable approaches to implement the functionality of any detail described herein. Therefore, any approach may extend beyond the particular implementation choices in the following embodiments described and shown.

References to “one embodiment,” “an embodiment,” “at least one embodiment,” “one example,” “an example,” “for example,” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

It is noted that various connections are set forth between elements in the following description and in the drawings (the contents of which are included in this disclosure by way of reference). It is noted that these connections in general and, unless specified otherwise, may be direct or indirect and that this specification is not intended to be limiting in this respect. In this respect, a coupling between entities may refer to either a direct or an indirect connection.

In the following description, the terms “footpath” and “stairs” may be used interchangeably to refer to an example pathway for which the safety system may be used. , Also, the accompanying drawings illustrate the footpath as being a staircase in some example embodiments. It should be understood that a staircase is only one example of a footpath that may be monitored with the safety system described below and is not intended to be limiting. The staircase is merely used for illustration purposes in the written description and the accompanying figures.

An embodiments of the present invention to be disclosed, wherein the fall protection system includes a weight sensor 12, a controller 20, wherein the controller may receive detections from the sensor, wherein the detection indicates that a person is about to fall from the stairs and upon detection the safety net 14 is deployed at an appropriate location, in response to the detected fall conditions from the sensor.

In an embodiment, the safety net 14 can br any net, or any air bag.

In an embodiment, the fall may also be recorded and may be stored in the memory unit attached to the system. This may enable one or more users to relook to the incident.

In a further embodiment, a display may be communicatively attached with the camera, which may display the incident that happened to one or more emergency contacts. One or more emergency contacts may be alerted upon detection of the fall incident.

The processor can execute instructions within the device, including instructions stored in the memory. The processor may be implemented as a chipset of chips that include separate and multiple analog and digital processors.

The processor may communicate with a user through a control interface and display interface coupled to a display. The display may be, for example, a TFT LCD (Thin-Film-Transistor Liquid Crystal Display) or an OLED (Organic Light Emitting Diode) display, or other appropriate display technology. The display interface may comprise appropriate circuitry for driving the display to present graphical and other information to a user. The control interface may receive commands from a user and convert them for submission to the processor. , Also, an external interface may be provided in communication with the processor, to enable near area communication of device with other devices. The external interface may provide, for example, for wired communication in some implementations, or wireless communication in other implementations, and multiple interfaces may also be used.

The memory stores information within the computing device. The memory can be implemented as one or more of a computer-readable medium or media, a volatile memory unit or units, or a non-volatile memory unit or units. Expansion memory may also be provided and connected to the device through an expansion interface, which may include, for example, a SIMM (Single In-Line Memory Module) card interface. Such expansion memory may provide extra storage space for the device, or may also store applications or other information for the device. Specifically, expansion memory may include instructions to carry out or supplement the processes described above and may include secure information also. Thus, for example, expansion memory may be provided as a security module for the device and maybe programmed with instructions that permit secure use of the device. Also, secure applications may be provided via the SIMM cards, along with additional information, such as placing identifying information on the SIMM card in a non-hackable manner.

The memory may include, for example, flash memory and/or -Non-Volatile RAM, as discussed below. In one implementation, a computer program product is tangibly embodied in an information carrier. The computer program product contains instructions that, when executed, perform one or more methods, such as those described above. The information carrier is a computer- or machine-readable medium, such as the memory, expansion memory, or memory on the processor.

According to an embodiment of the present invention to be disclosed, there is a link between the weight sensors 12 and the deployment of the safety net 14 at the appropriate location via controller 20, wherein the controller calculates where the point of impact will be, and accordingly, the safety net will be deployed to mitigate the fall.

According to an embodiment of the present invention to be disclosed, one or more of machine learning, neural networks, pattern recognition, and various related techniques commonly thought of under the broad rubric of artificial or the machine intelligence, also come very much into play to link what is sensed to what is deployed.

According to an embodiment of the present invention, the sensors 12 continuously monitor the human and send the resulting data to the controller 20. Controller 20 then recognizes that a fall is in progress as evidenced by the weight sensor. Upon detection of the fall, the controller sends a signal to a triggering mechanism to open the safety net 14 in a path of the trajectory of the falling person.

For instance, if two elderly people are standing close to each other and one begins to fall, the system may use logic to deploy safety net devices only for the falling person, without compromising the stability of the non-falling person. Or, the controller may sense that both will fall and pro-actively deploy a safety net for both of them.

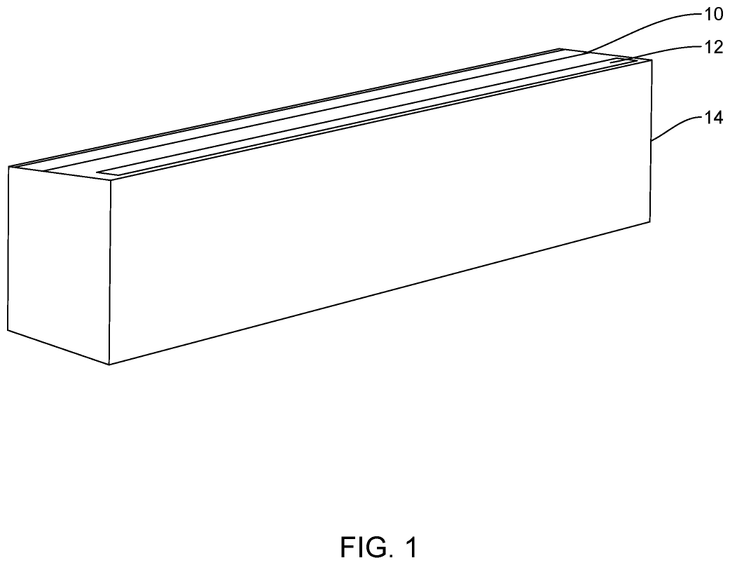

FIG. 1 shows a perspective schematic view illustrating a stair fall protection system, wherein the system includes a Slim Line casing (14), on top of the Slim Line casing (14) an openable Slot (10), further there is a weight-sensor (12) on top of the openable Slot (10).

According to the present invention shown in FIG. 1, the invention provides a fall protection system consisting of SlimLine casing (14), wherein the casing 14 includes a weight sensor. The weight sensor may be positioned on the stairs to prevent or break the fall of a child, disabled or an elderly person and a controller that actively provide a safety net behind the child, disabled or elderly person when they are climbing up or provide the safety netin front of the child, disabled or elderly person when they are climbing down.

According to the present invention, the system comprises a foldable or shutter-type SlimLine casing (14), wherein casing 14 is installed at each stair step (39)and when a child, a disabled, or elderly person is climbing up or down the stairs, the units are activated by the sensed information by the sensors, wherein all the SlimLine casing installed are connected to a central controller, Furthermore, the plurality of sensors are strategically located on the stairs. The plurality of sensors may be motionsensors, vibrationsensors, height, weight sensors, etc).

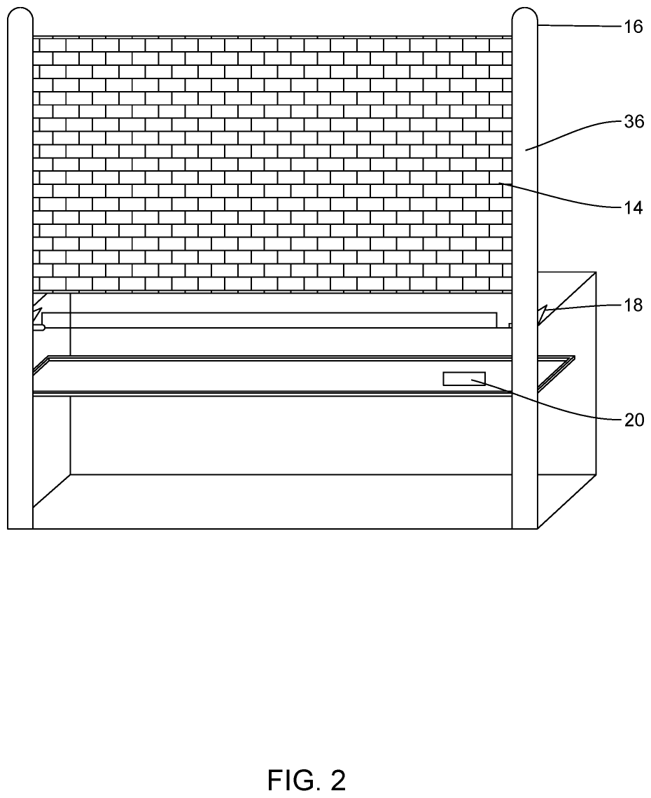

FIG. 2 shows a perspective schematic views illustrating a stair fall protection system, wherein the system includes a plurality of Expandable Retractable Rod (36), a Top Locking Latch (16), a Safety Net (14) attached on both sides to the Expandable Retractable Rod (36), a Stopper Slot and Mechanism (18), and a controller (20) at the bottom of the Slim-Line Casing (14).

In an embodiment of the present invention, the top Locking Latch (16) holds the Expandable Retractable Rod (36).

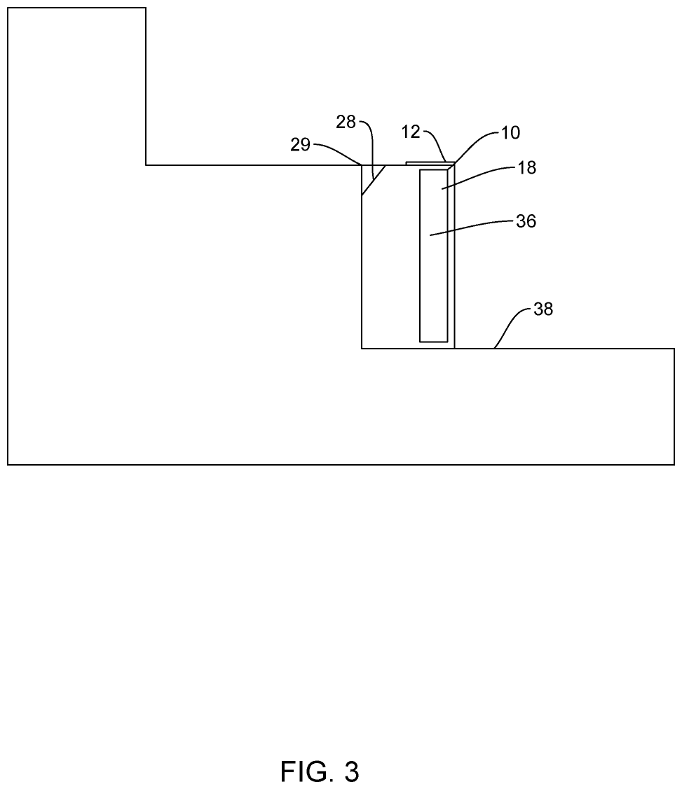

FIG. 3 perspective schematic views illustrating a stair fall protection system, wherein the system includes a top openable slot (10) is connected with spring (28) while the top openable slot (10) is attached with a hinge (29). On top of the openable slot (10) is a weight sensor (12). On the inside frontal position is the Stopper Slot and Mechanism (18). Expandable Retractable Rod (36) is shown as a vertical shaft.

An alternate embodiment of the present invention is as shown in FIG. 2 consists of a safety net, wherein the Safety Net (14) attached on both sides to the Expandable Retractable Rod (36), a controller (20)activates the system and each of the safety nets will be activated and flipped into position successively based on the location of the child, disabled or elderly on the stairs. For example, when the person steps on the stair-step the shoe or feet step upon the Weight Sensor (12). The said sensor is on top of the Openable Slot (10) which is part of the SlimLine casing (14).

In the case of a fall, the weight sensor senses a sudden drop of weight while the other weight in the immediate up or down steps will not be giving any normal consecutive weight-related reading. Thus the sensor sends the signal to the controller which in turn sends the signal to the triggering mechanism to eject Expendable Retractable Rod (36) and come-out of the openable-slot (10). The safety net (14) that is attached with the said Expendable Retractable Rod spreads covering the full width of the stair-step (36). The top Locking Latch (16) holds the rod (36).Hence stopping the falling person right in the place.

According to an embodiment of the present invention, once the safety-net (14) and the retractable rod (36) needs to be closed back to their original position, a little hand pressure on top of the said retractable rod (36) puts it back in its place inside the casing (14) while locking it using the Stopper Slot and Mechanism (18), wherein a spring (28) keeps the openable slot (10) in its horizontal position.

According to an embodiment of the present invention, the invention includes sensors, generally denoted as 12, employed to detect a fall, wherein the sensor senses a sudden drop of weight while the other weight in the immediate up or down steps will not be giving any normal consecutive weight-related reading. Further various considerations involved in Sensors 12, as discussed above, sensor 12 is used to sense position and motion, and this information is fed into a controller, wherein the weight sensor detects the weight of the person as well as weight shifts to detect a definite fall.

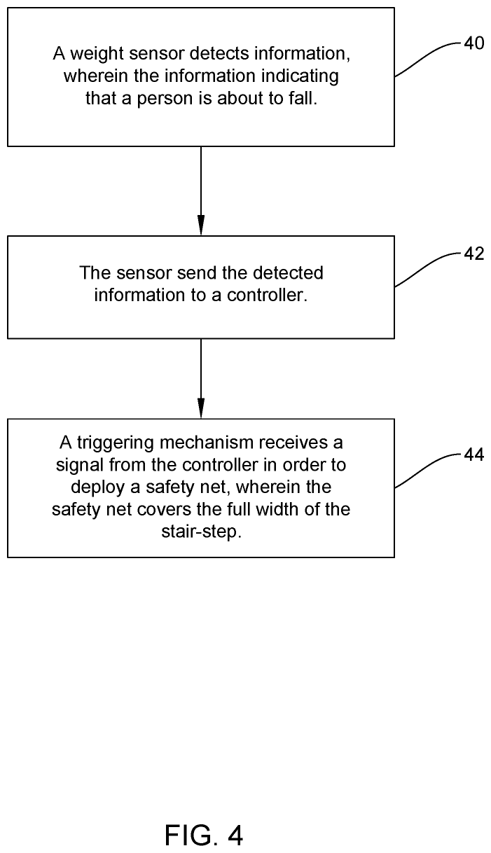

FIG. 4 shows a flow diagram according to the present invention, wherein at step 40 a weight sensor detects information, wherein the information indicates that a person is about to fall.

The process starts at step 42, at step 42, a controller receives the information from the sensor, at step 44, a triggering mechanism receives a signal from the controller to deploy a safety net, wherein the safety net covers the full width of the stair-step.

Having set out the general considerations underlying the system, devices, and methods disclosed herein, we now turn to examine this system in several specific embodiments for stairways, bathrooms, and bedrooms. The enumeration of these three specific embodiments in no way precludes the application of the disclosures herein to other embodiments, and other such embodiments are regarded to be within the scope of this disclosure and its associated claims.

According to an embodiment of the present invention, the system can be powered electrically or mechanically and can be wound up using a rechargeable supply or any other power source. Ordinarily, the system would normally be ON but a switch on the controller can be used for deactivating the system if a user does not need assistance going up or down the stairs.

Various embodiments of the invention have been disclosed. However, it should be apparent to those skilled in the art that modifications in addition to those described, are possible without departing from the inventive concepts herein. The embodiments, therefore, are not restrictive, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, or utilized, or combined with other elements, components, or steps that are not expressly referenced.

It is to understand that while certain embodiments have been described, the invention contemplates other changes and modifications, such as by way of example, that the curtain of the lower safety bar may be in the form of a net with a weighted bottom. Other changes and modifications may be made without departing from the spirit or scope of the invention as defined in the adjoined claims.

It is therefore submitted that the instant invention has been shown and described in what is considered to be the most practical and preferred embodiments. It is recognized, however, that departures may be made within the scope of the invention and that obvious modification will occur to a person skilled in the art. With respect to the above description then, it is to be realized that the optimum dimensional relationships for the parts of the invention, to include variations in size, materials, shape, form, function, and manner of operation, assembly, and use, are deemed readily apparent and obvious to one skilled in the art, and all equivalent relationships to those illustrated in the drawings and described in the specification are intended to be encompassed by the present invention.

While in the foregoing specification, several embodiments of the invention have been set forth for purposes of making a complete disclosure, it will be apparent to those skilled in the art that numerous changes may be made without departing from the spirit and principles of the invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

Although the present invention has been explained in relation to its some embodiments, it is to be understood that many other possible modifications and variations can be made without departing from the Spirit and Scope of the invention as hereinafter claimed.

### REFERENCE NUMERALS

### 10 Openable Slot

### 12 Weight Sensor

### 14 Slim-Line Casing

### 16 Top Locking Latch

### 36 Expendable Retractable Rod

### 14 Safety Net

### 18 Stopper Slot and Mechanism

### 12 Weight Sensor

### 20 Controller

### 28 Spring

### 29 Hinge

### 12 Weight Sensor

### 10 Openable Slot

### 18 Stopper Slot and Mechanism

### 36 Expandable Retractable Rod

### 38 Stairs

### 39 Stairs-Step

What is claimed is:

1. A fall protection system comprising:
one or more sensors configured to detect a fall;
a controller configured to receive an input from said one or more sensors; and
at least one safety net, wherein said safety net is deployed in response to received input by said controller, wherein said input is fall detection sensed by said one or more sensors.

2. The fall protection system of claim 1, comprises at least a weight sensor in said one or more sensors.

3. The fall protection system of claim 1 further comprises an alarming unit.

4. A fall protection system comprising:
a weight sensor;
a controller, to receiving detections from said sensor, wherein the detection indicating that a person is about to fall; and
at least one safety net, for deployment at at-least one location in response to said detecting fall conditions.

5. The fall protection system of claim 4 further comprises an alarming unit.

6. The fall protection system of claim 1 further comprises a memory device to store the fall incident.

7. The system of claim 1, wherein:
said controller deduces said fall conditions by sensing a sudden drop of weight while the other weight in the immediate up or down steps will not be giving any normal consecutive weight-related reading.

8. The system of claim 1, wherein:
at least one of said safety net, prior to said deployment, is positioned beneath a landing of a stair.

9. The system of claim 1, wherein the system further comprises a plurality of Expendable Retractable Rods, wherein the rod comprising: an attachment mean, wherein the attachment means adapted to configure an extension and/ or retraction thereof said rod to and/or away from an underneath portion of the stairs.

10. The system of claim 1, wherein the Safety net is attached in between the Expendable Retractable Rod.
